(19) United States
(12) Patent Application Publication
(10) Pub. No.: US 2022/0228640 A1
(43) Pub. Date: Jul. 21, 2022

(54) STROKE CUSHIONING IN PISTON AND CYLINDER DEVICES

(71) Applicant: Hydra Dyne Technology Inc., Ingersoll (CA)

(72) Inventors: Stephan E. BOHNER, Woodstock (CA); Robert KROPINIEWICZ, London (CA); Alisha Marie KOOT, Thamesford (CA)

(21) Appl. No.: 17/615,292

(22) PCT Filed: May 31, 2019
(86) PCT No.: PCT/CA2019/050765

§ 371 Date: Nov. 30, 2021

(51) Int. Cl. F16F 9/49; F16F 9/58

(52) U.S. Cl. CPC F16F 9/49; F15B 15/223; F16F 9/585

(57) ABSTRACT

In a piston and cylinder device, such as a hydraulic cylinder, potential or kinetic energy of the piston just before reaching the cylinder head at the end of a stroke can be mitigated using a rod spud/cushion sleeve arrangement where the rod spud and cushion sleeve comprise complementary continuously and gradually tapered portions forming an annular orifice having a cross-sectional area that dynamically, continuously and gradually decreases as an external tapered portion of the rod spud moves through an internal tapered portion of the cushion sleeve to the end of the piston stroke.

### FIELD

This application relates to piston and cylinder devices, more particularly to cushioning an end stroke movement of a piston and cylinder device.

### BACKGROUND

It is common practice to utilize cushioning devices in a piston and cylinder device (e.g. a hydraulic cylinder, hydraulic jack and the like) to prevent high velocity contact of the piston and cylinder head. Such cushioning devices may utilize a cushion sleeve, which restricts the passage of fluid into an exit port. Such restriction causes back pressure on the piston, thereby slowing the piston at the end of the piston's stroke. However, such cushioning devices provide deceleration only until the piston has traveled to within a very short distance of the cylinder head and may not dissipate enough of the velocity of the piston before reaching the cylinder head

Attempts to improve the cushioning of the piston have been made in the art. For example, U.S. Pat. No. 3,964,370 describes a cushioning arrangement in which a rod spud is provided with steps to periodically reduce the diameter of the spud. However, such an arrangement does not provide an ideal cushioning, rather results in step-wise pressure changes during cushioning of the piston as the piston approaches the end of the stroke.

There remains a need for cushioning the end stroke of a piston and cylinder device in such a way to better control and complete deceleration of the piston at the very end of the stroke.

### SUMMARY

In one aspect, there is provided a piston and cylinder device comprising: a barrel having a base end and a flange end opposite the base end; a base mounted on the base end of the barrel, the base comprising a base end hydraulic fluid port permitting flow of a hydraulic fluid into and out of the barrel from and to a hydraulic fluid circuit; a gland mounted on the flange end of the barrel, the gland comprising a gland end hydraulic fluid port permitting flow of the hydraulic fluid into and out of the barrel from and to the hydraulic fluid circuit; and, a piston assembly situated inside the barrel, the piston assembly comprising a piston mounted on a piston rod, the piston assembly moveable along a longitudinal axis of the barrel under hydraulic fluid pressure in the barrel to permit piston strokes between the base and the gland, wherein the piston rod comprises a rod spud, and the base comprises a base end cushion sleeve for receiving the rod spud as the piston assembly approaches an end of the piston stroke at the base, wherein the rod spud comprises a proximal end and a distal end, the proximal end situated closer to the piston than the distal end, wherein the rod spud comprises an external tapered portion having a taper length of at least 25% of a length of the rod spud such that the rod spud continuously and gradually narrows proximally to distally over the taper length and the base end cushion sleeve comprises a continuously and gradually narrowing internal tapered portion complementary to the external tapered portion of the rod spud, wherein the rod spud comprises an outer surface and the base end cushion sleeve comprises an inner surface, the outer surface of the rod spud and the inner surface of the base end cushion sleeve defining an annular orifice between an internal volume of the barrel and an interior of the base cushion sleeve, the annular orifice having a cross-sectional area that dynamically, continuously and gradually decreases as the external tapered portion of the rod spud moves through the internal tapered portion of the base end cushion sleeve to the end of the piston stroke at the base, the annular orifice having a length that dynamically, continuously and gradually increases as the external tapered portion of the rod spud moves through the external tapered portion of the base end cushion sleeve to the end of the piston stroke at the base.

In another aspect, there is provided a piston and cylinder device comprising a barrel and a piston assembly situated inside the barrel, the piston assembly comprising a piston mounted on a piston rod, the piston assembly moveable along a longitudinal axis of the barrel under hydraulic fluid pressure in the barrel to permit piston strokes in the barrel, the barrel fluidly connectable to a hydraulic fluid reservoir for supplying hydraulic fluid to the device, wherein the piston rod comprises a rod spud or a rod collar and an end of the barrel comprises a cushion sleeve for receiving the rod spud or rod collar as the piston assembly approaches an end the piston stroke at the end of the barrel, the cushion sleeve having an inner surface comprising a resiliently deformable material that is more deformable under load than a spud or collar material of which the rod spud or rod collar is comprised, whereby the resiliently deformable material is deformable to assist with alignment of the rod spud or rod collar in the cushion sleeve.

In another aspect, there is provided a piston and cylinder device comprising a barrel, a base mounted on a base end of the barrel and a gland mounted on a flange end of the barrel opposite the base end, and a piston assembly situated inside the barrel, the piston assembly comprising a piston mounted on a piston rod, the piston assembly moveable along a longitudinal axis of the barrel under hydraulic fluid pressure in the barrel to permit piston strokes in the barrel between the gland and the base, the barrel fluidly connectable to a hydraulic fluid reservoir for supplying hydraulic fluid to the device, wherein the piston rod comprises a rod collar, and the gland comprises a gland throat for receiving the rod collar as the piston assembly approaches an end of the piston stroke at the gland, wherein the rod collar comprises a proximal end and a distal end, the proximal end situated closer to the piston than the distal end, wherein the rod collar comprises an outer surface and the gland throat comprises an inner surface, the outer surface of the rod collar comprising at least one whistle notch situated at the distal end of the rod collar, whereby the outer surface of the rod collar and the inner surface of the gland throat substantially prevent the hydraulic fluid from flowing therebetween except at the at least one whistle notch when the rod collar moves through the gland throat, wherein the outer surface of the rod collar in the at least one whistle notch and the inner surface of the gland throat form a collar orifice therebetween, and the outer surface of the rod collar in the at least one whistle notch tapers longitudinally along the outer surface of the rod collar such that the collar orifice has a cross-sectional diameter that dynamically, continuously and gradually decreases as the rod collar moves through the gland throat to the end of the piston stroke at the gland.

In another aspect, there is provided a piston and cylinder device comprising a barrel, a base mounted on a base end of the barrel and a gland mounted on a gland end of the barrel opposite the base end, and a piston assembly situated inside the barrel, the piston assembly comprising a piston mounted on a piston rod, the piston assembly moveable along a longitudinal axis of the barrel under hydraulic fluid pressure in the barrel to permit piston strokes in the barrel between the gland and the base, the barrel fluidly connectable to a hydraulic fluid reservoir for supplying hydraulic fluid to the device through a base end hydraulic fluid port in the base and a gland end hydraulic fluid port in the gland, wherein the gland comprises a gland end relief valve connecting the gland end hydraulic fluid port to the barrel on a gland side of the piston as the piston moves toward an end of the piston stroke at the gland, wherein the gland end relief valve opens if the hydraulic fluid pressure at the flange end exceeds a flange end safety pressure limit to permit the hydraulic fluid to flow past the gland end relief valve into the gland end hydraulic fluid port to relieve the hydraulic fluid pressure at the flange end, and wherein the base comprises a base end check and relief valve connecting the base end hydraulic fluid port to the barrel on a base side of the piston as the piston moves toward an end of the piston stroke at the base, wherein the base end check and relief valve opens if the hydraulic fluid pressure at the base end exceeds a base end safety pressure limit to permit the hydraulic fluid to flow past the base end check and relief valve into the base end hydraulic fluid port to relieve the hydraulic fluid pressure at the base end.

In certain aspects of the present invention, at least one cushion sleeve is utilized to restrict passage of hydraulic fluid into a hydraulic fluid port at an end of the device as the piston approaches an end of the piston stroke at that end of the device. The cushion sleeve may be at one or both ends of the device. The restriction causes back pressure on the piston thereby slowing the piston as the piston approaches the end of the piston stroke. The restriction is provided by an outer surface region of the piston rod and an inner surface region of the cushion sleeve forming an orifice between an interior of the cushion sleeve and the internal volume of the barrel when the outer surface region of the piston rod first enters the cushion sleeve at the inner surface region. The orifice is narrowed in comparison to a diameter or cross-sectional area of the cushion sleeve, and even more narrowed in comparison to a diameter or cross-sectional area of the internal volume of the barrel. Hydraulic fluid flow from the internal volume of the barrel into the hydraulic fluid port is thereby restricted because the hydraulic fluid is only able to reach the hydraulic fluid port through the narrowed orifice, because the hydraulic fluid port is in fluid communication with the internal volume of the barrel through the cushion sleeve.

When the outer surface region of the piston rod first enters the cushion sleeve at the inner surface region, there is an abrupt increase in the hydraulic fluid back pressure between the piston and the end of the barrel toward which the piston is moving. To provide a substantially constant hydraulic fluid back pressure as the outer surface region of the piston rod moves through the cushion sleeve and to prevent or at least mitigate sudden piston acceleration at the very end of the piston stroke, the orifice formed between the outer surface region of the piston rod and the inner surface region of the cushion sleeve dynamically, continuously and gradually closes. To dynamically, continuously and gradually close, the orifice is designed to provide one or more of the following dynamic, continuous and gradual changes as the outer surface region of the piston rod moves through the inner surface region of the cushion sleeve:
a dynamically, continuously and gradually decreasing cross-sectional area of the orifice, preferably dynamically, continuously and gradually decreasing quadratically;
a dynamically, continuously and gradually increasing length of the orifice;
a dynamically, continuously and gradually decreasing separation between the outer surface of the piston rod and the inner surface of the cushion sleeve; and,
a dynamically, continuously and gradually decreasing volume of hydraulic fluid in the orifice.

A parameter that changes dynamically, continuously and gradually is a parameter that does not retain the same value over time and does not exhibit a change in the rate of change over that time. The dynamic, continuous and gradual change creates a period of substantially constant hydraulic fluid back pressure from a time just after the abrupt pressure increase in back pressure when the outer surface region of the piston rod first enters the inner surface region of the cushion sleeve to a time just before the end of the stroke. At the end of the stroke, the hydraulic fluid back pressure abruptly decreases without abrupt piston acceleration, thereby preventing the piston from slamming against the end of the barrel.

The one or more dynamic, continuous and gradual changes may be accomplished by any one of a number of different embodiments, including providing the piston rod with a continuously and gradually tapered outer surface region, providing the cushion sleeve with a continuously and gradually tapered inner surface region, or providing the outer surface region of the piston rod and the inner surface region of the cushion sleeve with complementary continuous and gradual tapers. Both the flange end and the base end may utilize the same embodiment, or may utilize different embodiments to accomplish the one or more dynamic, continuous and gradual changes.

The orifice formed between the outer surface region of the piston rod and the inner surface region of the cushion sleeve is sized from when the outer surface region of the piston rod first enters the cushion sleeve at the inner surface region to the end of the stroke to provide sufficient back pressure of hydraulic fluid for a cushioning effect without preventing hydraulic fluid from moving through the orifice at all (at least until the end of the stroke) or increasing the back pressure beyond safety tolerances for the device. For example, the separation between the outer surface of the piston rod and the inner surface of the cushion sleeve from beginning to end may be set to provide a desired back pressure for cushioning, and the length of the inner surface of the cushion sleeve may be adjusted to dissipate more or less kinetic energy of the piston depending on the desired back pressure. Where a higher back pressure is desired, the separation between the outer surface of the piston rod and the inner surface of the cushion sleeve may be smaller while the length of the cushion sleeve may be longer.

In certain aspects of the present invention, at least a portion of the inner surface region of the cushion sleeve may comprise a resiliently deformable material that is more deformable under load than a material of which the outer surface of the piston rod is comprised. The resiliently deformable material is deformable to assist with alignment of the piston rod in the cushion sleeve. The resiliently deformable material also assists with ensuring that the size of the orifice remains its intended size despite a misalignment of the piston rod in the cushion sleeve, especially as the outer surface of the piston rod first enters the cushion sleeve at the inner surface region. In particularly preferred embodiments, the resiliently deformable material is bronze, especially SAE 660 bronze.

In certain aspects of the present invention, both the base and the gland may comprise relief valves that open and close fluid connections between the internal volume of the barrel and the respective base and gland end hydraulic ports. When the hydraulic fluid pressure at the base or flange end exceeds a respective safety pressure limit, the relief valve at that end opens to permit the hydraulic fluid to flow from the barrel past the relief valve into the hydraulic fluid port to relieve the hydraulic fluid pressure at that end. The relief valve at the base end may also be a check valve that can open to permit flow of hydraulic fluid from the base end hydraulic fluid port to a base end face of the piston to start an extension stroke after the piston rod assembly reaches the end of a retraction stroke at the base end.

Preferably, the piston and cylinder device is a hydraulic cylinder, hydraulic jack or the like.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a side cross-sectional view of a hydraulic cylinder in accordance with one embodiment of the invention;

FIG. 2A depicts a magnified view of a side cross-sectional view of a cap end of the hydraulic cylinder of FIG. 1 with a rod spud entering a base end cushion sleeve;

FIG. 2B depicts the view of FIG. 2A with half of the rod spud having moved into the cushion sleeve;

FIG. 3 depicts a series of side-cross-sectional views of a base end of the hydraulic cylinder of FIG. 1 as a piston rod assembly completes a retraction stroke, with a graph of hydraulic fluid back pressure (P) vs. time series (t) showing how the hydraulic fluid back pressure changes as the retraction stroke is completed;

FIG. 4A depicts a side cross-sectional view of a gland of the hydraulic cylinder of FIG. 1,

FIG. 4B depicts a side view of a rod collar for a rod for the hydraulic cylinder of FIG. 1;

FIG. 4C depicts a schematic drawing of a cross-sectional end view at a circular opening to a gland throat when the rod collar of FIG. 4B first enters the gland throat;

FIG. 4D depicts a schematic drawing of the cross-sectional view of FIG. 4C after the rod collar has moved part of the way through the gland throat;

FIG. 5 depicts the gland of FIG. 4A rotated 90-degrees about a longitudinal axis through a center of the gland;

FIG. 6 depicts a perspective view of the rod collar of FIG. 4B; and,

FIG. 7 depicts an exploded side cross-sectional view of a gland end of the hydraulic cylinder of FIG. 1 showing the gland separated from a flange end of a barrel of the hydraulic cylinder.

### DETAILED DESCRIPTION

With reference to the Figures, a hydraulic cylinder 1 comprises a barrel 2 having a base end 20 and a flange end 50 opposite the base end 20. The hydraulic cylinder 1 further comprises a base 21 mounted on the base end 20 of the barrel 2, and a gland 51 mounted on the flange end 50 of the barrel 2. The hydraulic cylinder 1 further comprises a piston assembly 80 situated in a cylindrical internal volume 3 of the barrel 2.

The base 21 comprises a base end hydraulic fluid port 22 in fluid communication with the barrel 2 and an external hydraulic fluid circuit (not shown) permitting flow of a hydraulic fluid into and out of the barrel 2 from and to the hydraulic fluid circuit. The base end hydraulic fluid port 22 is located proximate an end of a spud receiver 24.

The gland 51 comprises a gland end hydraulic fluid port 52 in fluid communication with barrel 2 and the external hydraulic fluid circuit permitting flow of a hydraulic fluid into and out of the barrel 2 from and to the hydraulic fluid circuit.

The piston assembly 80 comprises a piston 81 mounted around a cylindrical piston rod 82, the piston assembly 80 moveable in the internal volume 3 along a longitudinal axis of the barrel 2 under hydraulic fluid pressure in the barrel 2 to permit piston strokes between the base 21 and the gland 51. In operation, hydraulic fluid from the hydraulic fluid circuit enters the internal volume 3 of the barrel 2 through the base end hydraulic fluid port 22 at a base side of the piston 81 to push the piston 81 thereby extending the piston rod 82. While the piston rod 82 extends, hydraulic fluid on a gland side of the piston 81 is pushed out the gland end hydraulic fluid port 52 into the hydraulic circuit. When the piston 81 reaches the end of an extension stroke, the flow of hydraulic fluid in the hydraulic circuit is reversed so that hydraulic fluid from the hydraulic fluid circuit enters the internal volume 3 of the barrel 2 through the gland end hydraulic fluid port 52 at a gland side of the piston 81 to push the piston 81 thereby retracting the piston rod 82. While the piston rod 82 retracts, hydraulic fluid on the base side of the piston 81 is pushed out the base end hydraulic fluid port 22 into the hydraulic circuit. When the piston 81 reaches the end of a retraction stroke, the flow of hydraulic fluid in the hydraulic circuit is reversed thereby repeating the extension stroke. Seals around the piston 81 prevent hydraulic fluid from passing passed the piston 81 between the base side and gland side of the piston. In this manner, the hydraulic cylinder 1 can operate continuously in a cyclical manner.

To help cushion the ends of the retraction and extension strokes, the base 21 and gland 51 are provided with a base end cushion sleeve 23 and a gland throat 53, respectively, and the piston rod 82 comprises a rod spud 83 and a rod collar 84, which are received by the base end cushion sleeve 23 and gland throat 53, respectively, as the piston rod 82 approaches the ends of the retraction and extension strokes, respectively. The gland throat 53 acts as a cushion sleeve in the gland 51. In both the base and the gland, the formation of orifices between inner surface regions of the cushion sleeves 23, 53 and outer surface regions of the rod spud 83 and rod collar 84, respectively, when the outer surface regions first meet the respective inner surface regions as the rod spud 83 and rod collar 84 move through the respective cushion sleeves 23, 53, causes an abrupt increase in hydraulic fluid pressure, which slows the piston assembly 80 as the piston 81 nears the end of the stroke.

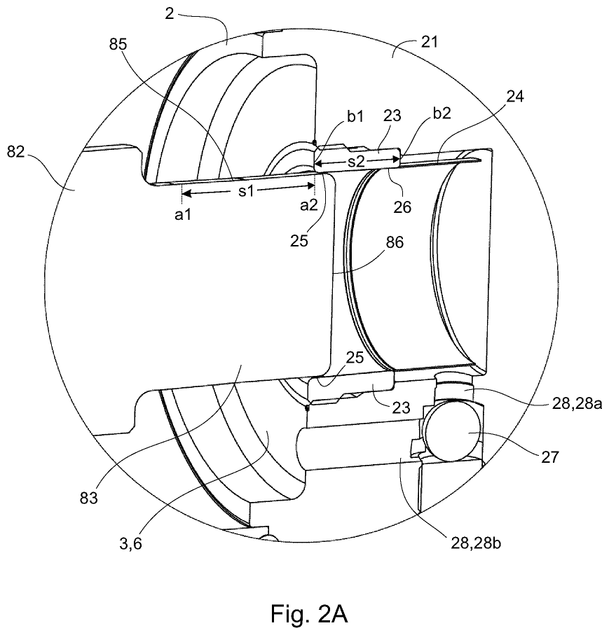

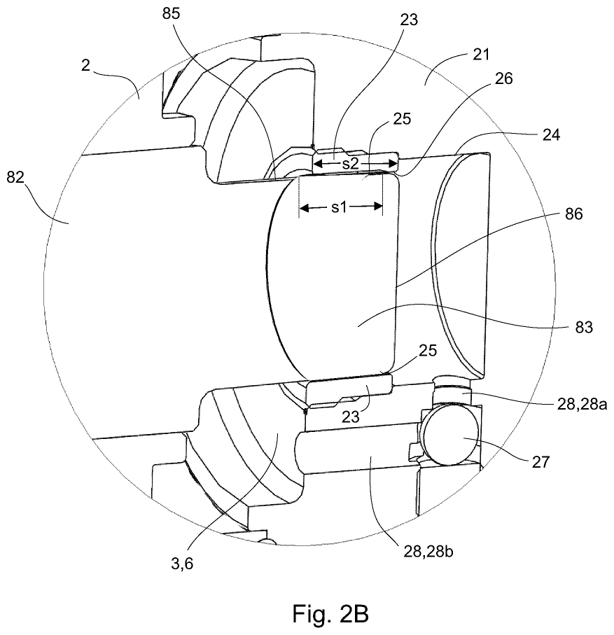

Details at a cap end of the hydraulic cylinder 1 are shown in FIG. 2A, FIG. 2B and FIG. 3. In FIG. 2A, the rod spud 83 is shown having entered the base end cushion sleeve 23 as the piston assembly 80 approaches the end of the retraction stroke. In FIG. 2B, half of the rod spud 83 has moved into the base end cushion sleeve 23 as the piston assembly 80 approaches the end of the retraction stroke.

The rod spud 83 comprises an outer surface 85 having an external tapered portion s1 that narrows in diameter continuously and gradually from a location a1 proximate the piston rod 82 to a location a2 farther toward a chamfered end 86 of the rod spud 83. The outer surface 85 of the rod spud 83 between the location a2 and the chamfer at the end 86 is straight without any tapering. The outer surface 85 of the rod spud 83 between the location a1 and the remainder of the piston rod 82 is also straight. The external tapered portion s1 tapers at a very slight taper angle relative to a longitudinal axis of the rod spud 83, the taper angle being less than 1°. The base end cushion sleeve 23 comprises an inner surface 26 having an internal tapered portion s2 that narrows in diameter continuously and gradually from a location b1 at a proximal end of the base end cushion sleeve 23 to a location b1 at a distal end of the base end cushion sleeve 23. The internal tapered portion s2 tapers at the same taper angle as the taper angle of the external tapered portion s1.

As seen in FIG. 2A, when the external tapered portion s1 of the rod spud 83 first enters the internal tapered portion s2 of the base end cushion sleeve 23, an annular orifice 25 is formed. The annular orifice 25 is defined by the outer surface 85 of the rod spud 83 and the inner surface 26 of the base end cushion sleeve 23. Total cross-sectional area of the annular orifice 25 is determined by subtracting cross-sectional area of the rod spud 83 from cross-sectional area of the base end cushion sleeve 23 at a given longitudinal location where the rod spud 83 is in the base end cushion sleeve 23. Outside the base end cushion sleeve 23 in the internal volume 3, total cross-sectional area of an annular gap in a hydraulic fluid-filled space 6 around the rod spud 83 is determined by subtracting cross-sectional area of the rod spud 83 from cross-sectional area of the internal volume 3 at a given longitudinal location where the rod spud 83 is in the hydraulic fluid-filled space 6. The total cross-sectional area of the annular orifice 25 is about 1% of the total cross-sectional area of the annular gap when the external tapered portion s1 of the rod spud 83 first enters the internal tapered portion s2 of the base end cushion sleeve 23 (FIG. 2A). As the rod spud 83 moves through the base end cushion sleeve 23, the distance between the external tapered portion s1 and the internal tapered portion s2 dynamically, continuously and gradually becomes smaller, therefore the total cross-section area of the annular orifice 25 dynamically, continuously and gradually decreases. The area of the annular orifice 25 dynamically, continuously and gradually decreasing quadratically causing a linear increase in resistance at a constant hydraulic fluid back pressure. At the same time, a length of the annular orifice 25 dynamically, continuously and gradually increases, as seen when FIG. 2A is compared to FIG. 2B. In FIG. 2B, the distance between the external tapered portion s1 and the internal tapered portion s2 at locations a1 and a2 are the same; therefore, the total cross-sectional area of the annular orifice 25 is the same at locations a1 and a2 despite the total cross-sectional area of the annular orifice 25 being smaller in FIG. 2B than in FIG. 2A. Selection of the of orifice size permits tuning the hydraulic fluid back pressure for the particular type of device. For example, gradually decreasing the distance between the external tapered portion s1 and the internal tapered portion s2 from 0.010″ to 0.002″ is suitable for many hydraulic cylinder applications.

The base end cushion sleeve 23 comprises a bushing composed of a softer material (e.g. SAE 660 bronze) than the material of the rod spud 83. The base end cushion sleeve 23 is seated in the spud receiver 24, the spud receiver 24 being a cylindrical cavity in the base 21 having a smaller diameter than the internal volume 3 of the barrel 2 and a larger diameter than the rod spud 83. The spud receiver 24 receives the rod spud 83 as the rod spud 83 reaches the end of the retraction stroke. The base end cushion sleeve 23 is immovably seated within the spud receiver 24 by threading and crimping. Because the base end cushion sleeve 23 is softer than the rod spud 83, the base end cushion sleeve 23 is deformable under contact with the rod spud 83 to assist with alignment of the rod spud 83 in the base end cushion sleeve 23 when the rod spud 83 first enters the base end cushion sleeve 23. Further, deformation of the base end cushion sleeve 23 assists with maintaining a constant annular orifice size as the rod spud 23 moves through the base end cushion sleeve 23.

With reference to FIG. 2A, FIG. 2B and particular reference to FIG. 3, in operation, as the piston assembly 80 approaches the end of the retraction stroke, hydraulic fluid is forced out the base end hydraulic fluid port 22, which is in fluid communication with the barrel 2 through the spud receiver 24. At t1, before the external tapered portion s1 of the rod spud 83 first enters the internal tapered portion s2 of the base end cushion sleeve 23, the hydraulic fluid back pressure P on the base-side of the piston 81 is relatively constant and relatively low because hydraulic fluid can flow freely through the spud receiver 24 to the base end hydraulic fluid port 22. At t2, when the external tapered portion s1 of the rod spud 83 first enters the internal tapered portion s2 of the base end cushion sleeve 23, the hydraulic fluid in the hydraulic fluid-filled space 6 around the rod spud 83 must now flow through the annular orifice 25 to get to the base end hydraulic fluid port 22. Because the total cross-sectional area of the annular orifice 25 is about 1% of the total cross-sectional area of the annular gap in the hydraulic fluid-filled space 6 at t2, there is a spike in hydraulic fluid back pressure P on the base-side of the piston 81. This spike in hydraulic fluid back pressure P causes the piston assembly 80 to decelerate. During deceleration, the rod spud 83 continues to move through the base end cushion sleeve 23. At t3, half of the rod spud 83 has moved into the base end cushion sleeve 23. At t4, the piston assembly 80 completes the retraction stroke. In the period from t2 through t3 to just before t4, the annular orifice 25 dynamically, continuously and gradually decreases in cross-sectional area, which equates to a continuous and gradual decrease in the amount of hydraulic fluid in the orifice and a dynamic, continuous and gradual decrease in the distance between the outer surface 85 of the external tapered portion s1 of the rod spud 83 and the inner surface 26 of the internal tapered portion s2 of the base end cushion sleeve 23. The dynamic, continuous and gradual changes keep the hydraulic fluid back pressure P constant during the deceleration of the piston assembly 80 until the end of the retraction stroke at t4 where the hydraulic fluid back pressure P abruptly drops as the piston assembly 80 stops. Further, there is no, or only an insignificant, spike in hydraulic fluid back pressure P when the piston assembly 80 reaches the end of the retraction stroke.

At t4, the end 86 of the rod spud 83 abuts or almost abuts the end of the spud receiver 24, the annular orifice 25 is now too small for hydraulic fluid to flow through and the rod spud 83 blocks hydraulic fluid flow from the base end hydraulic fluid port 22 to the end 86 of the rod spud 83. It is a particular advantage that the size of the annular orifice 25 can be closed entirely, with the bronze bushing of the base end cushion sleeve 23 deforming to provide a mechanical stop for the piston assembly 80. In order to be able to start the extension stroke, the base 2 is provided with a base end check and relief valve 27 in a valve conduit 28 that fluidly connects the base end hydraulic fluid port 22 through the spud receiver 24 to the internal volume 3 of the barrel 2 on the base-side of the piston 81. Hydraulic fluid flowing from the hydraulic circuit into the base end hydraulic fluid port 22 passes around a perimeter of the rod spud 83 into a first portion 28a of the valve conduit 28 with sufficient pressure to force the base end check and relief valve 27 open so that hydraulic fluid can flow through a second portion 28b of the valve conduit 28 into the internal volume 3 where the hydraulic fluid can exert pressure on the piston 81 to start the extension stroke. Once the extension stroke has started, the hydraulic fluid can flow to exert pressure on the end 86 of the rod spud 83.

During the retraction stroke, hydraulic fluid flows from the internal volume 3 through the second portion 28b of the valve conduit 28 to close the base end check and relief valve 27 forcing the hydraulic fluid to flow only through the annular orifice 25 when the external tapered portion s1 of the rod spud 83 first enters the internal tapered portion s2 of the base end cushion sleeve 23. If the hydraulic fluid back pressure P exceeds a pre-determined safety pressure limit during the retraction stroke, the base end check and relief valve 27 opens to permit hydraulic fluid to flow to the base end hydraulic fluid port 22 to relieve the pressure to protect the hydraulic cylinder 1 from damage and to protect any workers in the area.

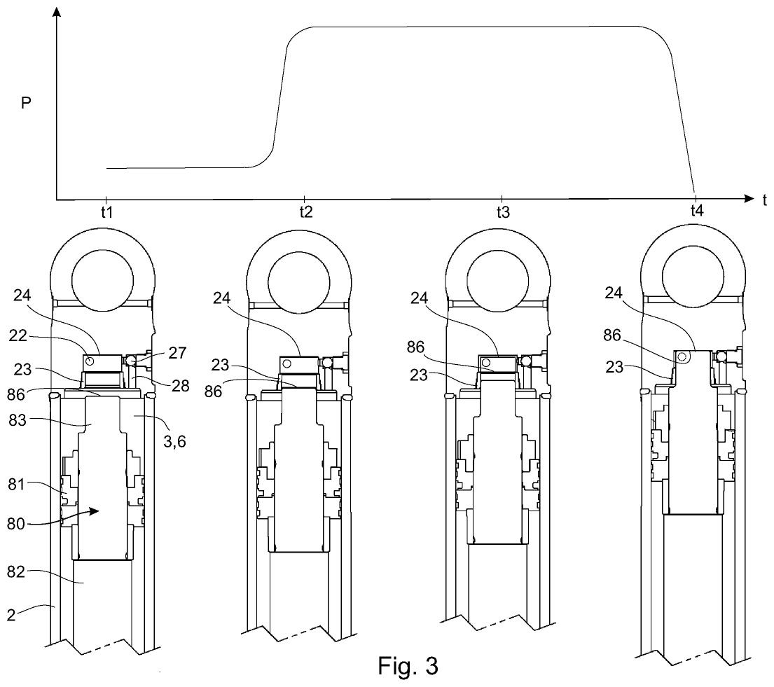

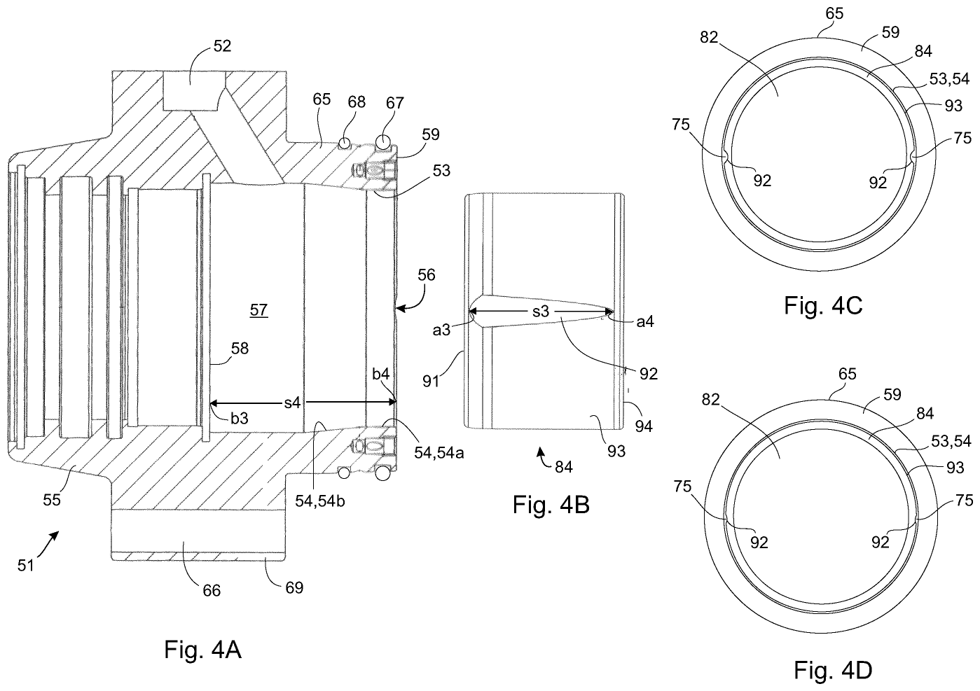

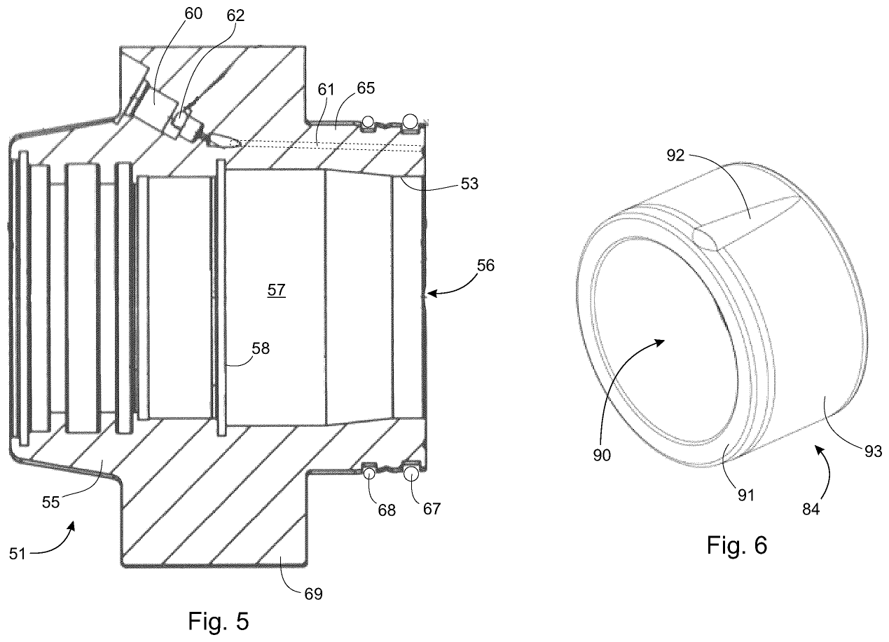

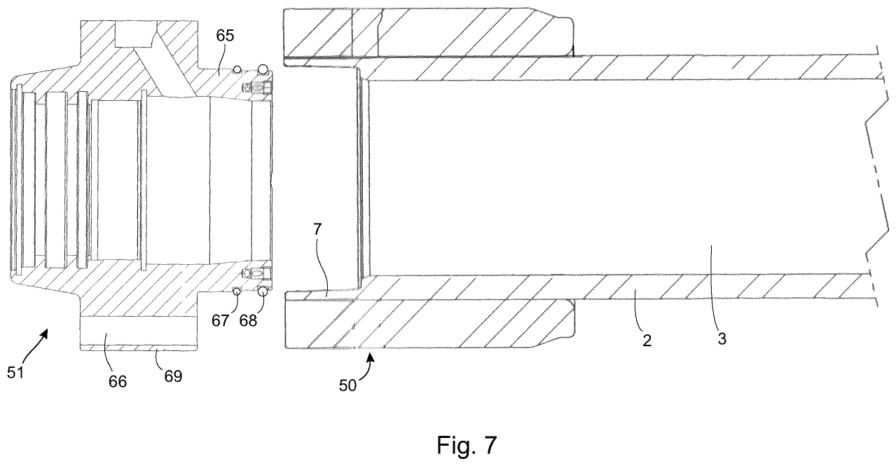

Details at a gland end of the hydraulic cylinder 1 are shown in FIG. 4A, FIG. 4B, FIG. 4C, FIG. 4D, FIG. 5, FIG. 6 and FIG. 7. FIG. 4A together with FIG. 4B illustrate how the gland 51 (FIG. 4A) and the rod collar 84 (FIG. 4B) line up as the rod collar 84 approaches the gland 51 near the end of the extension stroke of the piston assembly 80. FIG. 4C and FIG. 4D show how collar orifices 75 between the rod collar 84 and the gland throat 53 are formed and change as the rod collar 84 moves through the gland throat 53. FIG. 5 shows the gland 51 rotated 90-degrees about a longitudinal axis through a center of the gland 51 to show details not seen in FIG. 4A. FIG. 6 shows the rod collar 84 in perspective. FIG. 7 shows how the gland 51 lines up with the barrel 2 of the hydraulic cylinder 1.

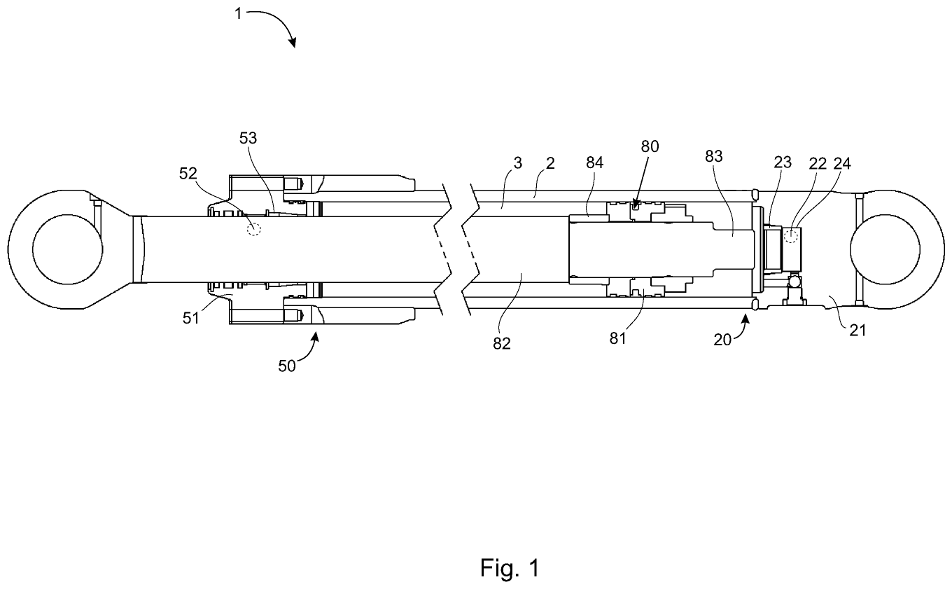

The rod collar 84 is cylindrical having a cylindrical cavity 90 through which the piston rod 82 extends when the rod collar 84 is mounted on the piston rod 82 on the gland-side of the piston 81, as seen in FIG. 1. The rod collar 84 has a chamfered distal face 91 facing the gland 51 and two whistle notches 92 inscribed in an outer surface 93 of the rod collar 84. The unshown whistle notch is the same as the shown whistle notch, and is situated on an opposite side of the rod collar 84, 180-degrees around the circumference of the cylinder of the rod collar 84. While two whistle notches 92 are provided in this embodiment, the rod collar may have 1, 2, 3, 4 or more whistle notches. The use of more notches requires a narrower annulus between the outer surface of the rod collar and the inner surface of the gland throat. The whistle notches 92 are grooves in the outer surface 93 of the rod collar 84, the grooves being wider and deeper at location a3 proximate the distal face 91 than at location a4 proximate a proximal end 94 of the rod collar 84, the proximal end 94 being closer to the piston 81 when the rod collar 84 is mounted on the piston rod 82. The whistle notch 92 continuously and gradually narrows and becomes shallower from a3 to a4 along a length s3 of the whistle notch 92. Therefore, the outer surface 93 of the rod collar 84 in the whistle notch 92 continuously and gradually tapers along the length s3 of the whistle notch 92.

The gland 51 comprises a block 55 that can be securely mounted on the flange end 50 of the barrel 2 (see FIG. 7), for example by bolting. The gland further comprises the gland throat 53, which forms a cavity 57 in the block 55, the gland throat 53 having an inner surface 54 extending between a distal location b3 to a proximal location b4 over a length s4. The gland throat 53 has a circular opening 56 in a proximal face 59 of the block 55 oriented to receive the rod collar 84 as the piston assembly 80 approaches the end of the extension stroke. The inner surface 54 of the gland throat 53 comprises a first portion 54a proximate the opening 56 and a second portion 54b between the first portion 54a and a distal end 58 of the gland throat 53.

During the extension stroke, and before the rod collar 84 reaches the gland throat 53, the hydraulic fluid in the internal volume 3 of the barrel 2 is able to pass through the full area of the circular opening 56 to be forced out of the hydraulic cylinder 1 through the gland end hydraulic fluid port 52 into the external hydraulic fluid circuit. As seen in FIG. 4C, when the rod collar 84 first enters the gland throat 53 at the circular opening 56, the clearance between the outer surface 93 of the rod collar 84 and the inner surface 54 of the gland throat 53 is sufficiently large to permit the rod collar 84 to move through the gland throat 53 and sufficiently small that the outer surface 93 of the rod collar 84 and the inner surface 54 of the gland throat 53 substantially prevent the hydraulic fluid in the internal volume 3 of the barrel 2 around the rod collar 84 from flowing therebetween except at the whistle notches 92 in the rod collar 84. The outer surface 93 of the rod collar 84 in the whistle notches 92 and the inner surface 54 of the gland throat 53 at the circular opening 56 form collar orifices 75 through which the flow of hydraulic is restricted. As a result, there is an initial abrupt spike in hydraulic fluid back pressure on the gland-side of the piston 81 when the rod collar 84 first enters the gland throat 53. This spike in hydraulic fluid back pressure causes the piston assembly 80 to decelerate.

During deceleration, the rod collar 84 continues to move through the gland throat 53. The inner surface 54 of the gland throat 53 may be straight or tapered away from a central longitudinal axis of the gland 51 (i.e. a reverse taper in comparison to the taper of the whistle notches 92). In both situations, as the rod collar 84 continues to move through the gland throat 53, the collar orifices 75 do not increase in length and remain line orifices at the circular opening 56, the collar orifices 75 bounded by the inner surface 54 of the gland throat 53 at the circular opening 56 and the outer surfaces 93 of the rod collar 84 in the whistle notches 92 somewhere between locations a3 and a4 depending on how far the rod collar 84 has moved through the gland throat 53.

As seen in FIG. 4D, though the collar orifices 75 do not change in length, because the whistle notches 92 are tapered to continuously and gradually narrow and become shallower from location a3 to location a4, the widths and the cross-sectional areas of the collar orifices 75 dynamically, continuously and gradually decrease, which equates to a continuous and gradual decrease in the amount of hydraulic fluid passing through the collar orifices 75 and a dynamic, continuous and gradual decrease in the distances between the outer surface 93 of the rod collar 84 in the whistle notches 92 and the inner surface 54 of the gland throat 53 at the circular opening 56. Thus, the outer surface 93 of the rod collar 84 in the whistle notches 92 tapers longitudinally along the rod collar 84 such that the collar orifices 75 have a cross-sectional diameter that dynamically, continuously and gradually decreases as the rod collar 84 moves through the gland throat 53 to the end of the extension stroke in the gland 51. The dynamic, continuous and gradual changes keep the hydraulic fluid back pressure constant during the deceleration of the piston assembly 80 until the end of the extension stroke at the distal end 58 of the gland throat 53, where the hydraulic fluid back pressure abruptly drops as the piston assembly 80 stops. Further, there is no, or only an insignificant, spike in hydraulic fluid back pressure when the piston assembly 80 reaches the end of the extension stroke.

The gland 51 of the hydraulic cylinder 1 is capable of handling about 15,000 psi of pressure. Because the whistle notches 92 dramatically increase the hydraulic fluid pressure around the rod collar 84 in the barrel 2 at the flange end 50 as the piston assembly 80 approaches the end of the extension stroke, certain measures may be taken to ensure that the gland 51 is not damaged during the extension stroke.

With reference to FIG. 5, the gland 51 may be machined to include a gland end relief valve 60 in fluid communication through a first conduit 61 with the internal volume 3 of the barrel 2 at the flange end 50 of the barrel 2 even when the rod collar 84 is in the gland throat 53. The gland end relief valve 60 is also in fluid communication with the gland end hydraulic fluid port 52 through a second conduit 62. The gland end relief valve 60 prevents hydraulic fluid from flowing from the barrel 2 into the gland end hydraulic fluid port 52 except via the collar orifices 75 while the piston assembly 80 approaches the end of the extension stroke and the rod collar 84 is in the gland throat 53. The gland end relief valve 60 opens if the hydraulic fluid pressure at the flange end 50 of the barrel 2 exceeds a flange end safety pressure limit to permit the hydraulic fluid to flow past the gland end relief valve 60 into the gland end hydraulic fluid port 52 to relieve the hydraulic fluid pressure at the flange end 50.

With reference to FIG. 7, the gland 51 is mounted on the flange end 50 of the barrel 3 by fitting a nose 65 of the gland 51 into a complementary gland seat 7 of the barrel 2. Once seated, the gland 51 is bolted to the gland seat 7 through a plurality of bolt holes 66 (only one shown) in a flange 69 of the gland 51. An o-ring 67 and a back-up o-ring 68 mounted around the nose 65 provide a fluid seal between an outer surface of the nose 65 of the gland 51 and an inner surface of the gland seat 7 of the barrel 2. The dramatic increase in hydraulic fluid pressure at the flange end 50 of the barrel 2 as the piston assembly 80 approaches the end of the extension stroke may cause the o-rings 67,68 to blow out due to expansion of the barrel 2 creating a gap between the gland seat 7 and the nose 65. To prevent the o-rings 67,68 from blowing out under the increased pressure, the outer surface of the nose 65 may be tapered to pre-load an outward load on the inner surface of the gland seat 7 at the flange end 50 of the barrel 2 when the gland 51 is bolted to the barrel 2. Therefore, when the hydraulic fluid pressure in the internal volume 3 of the barrel 2 spikes at the flange end 50 as the rod collar 84 enters the gland throat 53, the increase in pressure does not cause the barrel 2 to expand, thereby avoiding the creation of a gap between the gland seat 7 and the nose 65.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A piston and cylinder device comprising:
a barrel having a base end and a flange end opposite the base end;
a base mounted on the base end of the barrel, the base comprising a base end hydraulic fluid port permitting flow of a hydraulic fluid into and out of the barrel from and to a hydraulic fluid circuit;
a gland mounted on the flange end of the barrel, the gland comprising a gland end hydraulic fluid port permitting flow of the hydraulic fluid into and out of the barrel from and to the hydraulic fluid circuit; and,
a piston assembly situated in an internal volume of the barrel, the piston assembly comprising a piston mounted on a piston rod, the piston assembly moveable along a longitudinal axis of the barrel under hydraulic fluid pressure in the barrel to permit piston strokes between the base and the gland,
wherein the piston rod comprises a rod spud, and the base comprises a base end cushion sleeve for receiving the rod spud as the piston assembly approaches an end of the piston stroke at the base,
wherein the rod spud comprises a proximal end and a distal end, the proximal end situated closer to the piston than the distal end,
wherein the rod spud comprises an external tapered portion having a taper length of at least 25% of a length of the rod spud such that the rod spud continuously and gradually narrows proximally to distally over the taper length and the base end cushion sleeve comprises a continuously and gradually narrowing internal tapered portion complementary to the external tapered portion of the rod spud,
wherein the rod spud comprises an outer surface and the base end cushion sleeve comprises an inner surface, the outer surface of the rod spud and the inner surface of the base end cushion sleeve defining an annular orifice between the internal volume of the barrel and an interior of the base end cushion sleeve, the annular orifice having a cross-sectional area that dynamically, continuously and gradually decreases as the external tapered portion of the rod spud moves through the internal tapered portion of the base end cushion sleeve to the end of the piston stroke at the base, the annular orifice having a length that dynamically, continuously and gradually increases as the external tapered portion of the rod spud moves through the external tapered portion of the base end cushion sleeve to the end of the piston stroke at the base.

2. The device of claim 1, wherein:
the outer surface of the external tapered portion of the rod spud and the inner surface of the internal tapered portion of the base end cushion sleeve are separated by a separation distance perpendicular to the external tapered portion of the rod spud and the internal tapered portion of the base end cushion sleeve as the external tapered portion of the rod spud moves through the internal tapered portion of the base end cushion sleeve; and,
the separation distance dynamically, continuously and gradually decreases from 0.010 inch to 0.002 inch from when the external tapered portion of the rod spud first enters the internal tapered portion of the base end cushion sleeve to the end of the stroke.

3. The device of claim 1, wherein the outer surface of the rod spud and an inner surface of the barrel in the internal volume define an annular gap in the internal volume around the rod spud, and a cross-sectional area of the annular orifice is about 1% of a cross-sectional area of the annular gap when the external tapered portion of the rod spud first enters the internal tapered portion of the base end cushion sleeve.

4. The device of claim 1, wherein a volume of hydraulic fluid in the orifice dynamically, continuously and gradually decreases as the external tapered portion of the rod spud moves through the internal tapered portion of the base end cushion sleeve to the end of the piston stroke at the base.

5. The device of claim 1, wherein the distal end of the rod spud is chamfered, the rod spud comprises a non-tapered distal end portion and a non-tapered proximal end portion, and the external tapered portion of the rod spud is situated between the distal end portion and the proximal end portion.

6. The device of claim 1, wherein:
the base end cushion sleeve comprises a proximal end and a distal end, the proximal end situated closer to the piston than the distal end; and,
the inner surface of the proximal end of the base end cushion sleeve comprises a resiliently deformable material that is more deformable under load than a spud material of which the rod spud is comprised, whereby the resiliently deformable material is deformable to assist with alignment of the rod spud in the base end cushion sleeve and with maintaining a constant annular orifice size.

7. The device of claim 6, wherein the resiliently deformable material is SAE 660 bronze.

8. The device of claim 1, wherein:
the hydraulic fluid pressure in the barrel at the base end abruptly increases when the external tapered portion of the rod spud first enters the internal tapered portion of the base end cushion sleeve;
the hydraulic fluid pressure in the barrel at the base end remains substantially constant as the external tapered portion of the rod spud moves through the internal tapered portion of the base end cushion sleeve toward the end of the piston stroke at the base; and,
the hydraulic fluid pressure in the barrel at the base end abruptly decreases when the piston assembly reaches the end of the piston stroke.

9. The device of claim 8, wherein the base comprises a base end check and relief valve for preventing hydraulic fluid from flowing from the barrel into the base end hydraulic fluid port except via the annular orifice while the piston assembly approaches the end of the piston stroke at the base and the rod spud is in the base end cushion sleeve, wherein the base end check and relief valve opens if the hydraulic fluid pressure at the base end exceeds a base end safety pressure limit to permit the hydraulic fluid to flow past the base end check and relief valve into the base end hydraulic fluid port to relieve the hydraulic fluid pressure at the base end.

10. The device of claim 8, wherein the base end cushion sleeve has a length chosen as a function of the hydraulic fluid pressure at the base end to dissipate sufficient kinetic energy to prevent damage to the device during the piston stroke, whereby the length of the base end cushion sleeve is directly proportional to the hydraulic fluid pressure at the base end.

11. The device of claim 1,
wherein the piston rod comprises a rod collar, and the gland comprises a gland throat for receiving the rod collar as the piston assembly approaches an end of the piston stroke at the gland,
wherein the rod collar comprises a proximal end and a distal end, the proximal end situated closer to the piston than the distal end,
wherein the rod collar comprises an outer surface and the gland throat comprises an inner surface, the outer surface of the collar comprising at least one whistle notch situated at the distal end of the rod collar, whereby the outer surface of the rod collar and the inner surface of the gland throat substantially prevent the hydraulic fluid from flowing therebetween except at the at least one whistle notch when the rod collar moves through the gland throat,
wherein the outer surface of the rod collar in the at least one whistle notch and the inner surface of the gland throat form a collar orifice therebetween, and the outer surface of the collar in the at least one whistle notch tapers longitudinally along the outer surface of the rod collar such that the collar orifice has a cross-sectional diameter that dynamically, continuously and gradually decreases as the rod collar moves through the gland throat to the end of the piston stroke at the gland.

12. The device of claim 11, wherein the at least one whistle notch comprises a first whistle notch and a second whistle notch, the first and second whistle notches situated on opposites sides of the rod collar from each other.

13. The device of claim 11, wherein the gland comprises a gland end relief valve for preventing hydraulic fluid from flowing from the barrel into the gland end hydraulic fluid port except via the collar orifice while the piston assembly approaches the end of the piston stroke at the gland and the rod collar is in the gland throat, wherein the gland end relief valve opens if the hydraulic fluid pressure at the flange end exceeds a flange end safety pressure limit to permit the hydraulic fluid to flow past the gland end relief valve into the gland end hydraulic fluid port to relieve the hydraulic fluid pressure at the flange end.

14. A piston and cylinder device comprising a barrel and a piston assembly situated inside the barrel, the piston assembly comprising a piston mounted on a piston rod, the piston assembly moveable along a longitudinal axis of the barrel under hydraulic fluid pressure in the barrel to permit piston strokes in the barrel, the barrel fluidly connectable to a hydraulic fluid reservoir for supplying hydraulic fluid to the device,
wherein the piston rod comprises a rod spud or a rod collar and an end of the barrel comprises a cushion sleeve for receiving the rod spud or rod collar as the piston assembly approaches an end the piston stroke at the end of the barrel, the cushion sleeve having an inner surface comprising a resiliently deformable material that is more deformable under load than a spud or collar material of which the rod spud or rod collar is comprised, whereby the resiliently deformable material is deformable to assist with alignment of the rod spud or rod collar in the cushion sleeve.

15. The device of claim 14, wherein the resiliently deformable material is SAE 660 bronze.

16. A piston and cylinder device comprising a barrel, a base mounted on a base end of the barrel and a gland mounted on a flange end of the barrel opposite the base end, and a piston assembly situated inside the barrel, the piston assembly comprising a piston mounted on a piston rod, the piston assembly moveable along a longitudinal axis of the barrel under hydraulic fluid pressure in the barrel to permit piston strokes in the barrel between the gland and the base, the barrel fluidly connectable to a hydraulic fluid reservoir for supplying hydraulic fluid to the device,
wherein the piston rod comprises a rod collar, and the gland comprises a gland throat for receiving the rod collar as the piston assembly approaches an end of the piston stroke at the gland,
wherein the rod collar comprises a proximal end and a distal end, the proximal end situated closer to the piston than the distal end,
wherein the rod collar comprises an outer surface and the gland throat comprises an inner surface, the outer surface of the rod collar comprising at least one whistle notch situated at the distal end of the rod collar, whereby the outer surface of the rod collar and the inner surface of the gland throat substantially prevent the hydraulic fluid from flowing therebetween except at the at least one whistle notch when the rod collar moves through the gland throat,
wherein the outer surface of the rod collar in the at least one whistle notch and the inner surface of the gland throat form a collar orifice therebetween, and the outer surface of the rod collar in the at least one whistle notch tapers longitudinally along the outer surface of the rod collar such that the collar orifice has a cross-sectional diameter that dynamically, continuously and gradually decreases as the rod collar moves through the gland throat to the end of the piston stroke at the gland.

17. A piston and cylinder device comprising a barrel, a base mounted on a base end of the barrel and a gland mounted on a flange end of the barrel opposite the base end, and a piston assembly situated inside the barrel, the piston assembly comprising a piston mounted on a piston rod, the piston assembly moveable along a longitudinal axis of the barrel under hydraulic fluid pressure in the barrel to permit piston strokes in the barrel between the gland and the base, the barrel fluidly connectable to a hydraulic fluid reservoir for supplying hydraulic fluid to the device through a base end hydraulic fluid port in the base and a gland end hydraulic fluid port in the gland,
wherein the gland comprises a gland end relief valve connecting the gland end hydraulic fluid port to the barrel on a gland side of the piston as the piston moves toward an end of the piston stroke at the gland, wherein the gland end relief valve opens if the hydraulic fluid pressure at the flange end exceeds a flange end safety pressure limit to permit the hydraulic fluid to flow past the gland end relief valve into the gland end hydraulic fluid port to relieve the hydraulic fluid pressure at the flange end, and
wherein the base comprises a base end check and relief valve connecting the base end hydraulic fluid port to the barrel on a base side of the piston as the piston moves toward an end of the piston stroke at the base, wherein the base end check and relief valve opens if the hydraulic fluid pressure at the base end exceeds a base end safety pressure limit to permit the hydraulic fluid to flow past the base end check and relief valve into the base end hydraulic fluid port to relieve the hydraulic fluid pressure at the base end.

18. The device of claim 1, wherein the device is a hydraulic cylinder.
